(19) United States
(12) Patent Application Publication
(10) Pub. No.: US 2019/0031228 A1
(43) Pub. Date: Jan. 31, 2019

(54) ELECTRIC POWER STEERING DEVICE AND METHOD FOR MANUFACTURING ELECTRIC POWER STEERING DEVICE

(71) Applicant: KYB Corporation, Tokyo (JP)

(72) Inventors: Katsumi SHIMODA, Gifu (JP); Kazuyuki OKUMURA, Gifu (JP); Shinraku YOSHIKAWA, Gifu (JP)

(21) Appl. No.: 16/086,007

(22) PCT Filed: Feb. 16, 2017
(86) PCT No.: PCT/JP2017/005736

§ 371 Date: Sep. 18, 2018

(30) Foreign Application Priority Data
Mar. 25, 2016 (JP) 2016-062161

(51) Int. Cl. B62D 5/04; F16H 55/24; F16H 1/16; B62D 3/04; F16H 57/021

(52) U.S. Cl. CPC B62D 5/0454; F16H 55/24; F16H 1/166; F16H 2057/0213; B62D 5/0403; F16H 57/021; B62D 3/04

(57) ABSTRACT

An electric power steering device includes a worm shaft; a bearing rotatably supporting the worm shaft; a coil spring configured to bias the worm shaft toward the worm wheel via the bearing; a gear case including an insertion hole, the coil spring being insertable into the insertion hole; and plug configured to close the insertion hole. The plug includes a body part and a supporting part configured to support the coil spring. An outer peripheral surface of the plug is formed into a curved surface from the body part to the supporting part.

### TECHNICAL FIELD

The present invention relates to an electric power steering device and a method for manufacturing an electric power steering device.

### BACKGROUND ART

A conventional power steering device is known to reduce backlash between the teeth of a worm wheel and a worm shaft by biasing a bearing supporting the worm shaft meshed with the worm wheel by a spring.

As a power steering device of this type, an electric power steering device in which a spring is compressed between an outer peripheral surface of a bearing and a plug by press-fitting the plug into a through hole formed in a gear case is disclosed in JP2012-197029A. An O-ring is interposed between an outer peripheral surface of the gear case and a head part of the plug. A clearance between the gear case and the plug is sealed by the O-ring to tightly seal the gear case.

### SUMMARY OF INVENTION

In the electric power steering device disclosed in JP2012-197029A, the O-ring is provided between the plug and the gear case to increase the number of components. Further, the O-ring has to be mounted on the plug before the plug is press-fitted into the through hole of the gear case. Thus, it takes time to manufacture the power steering device.

To reduce the number of components and shorten a manufacturing time, it is thought to close the through hole only by press-fitting the plug and eliminate the O-ring. To this end, it is necessary to increase an outer diameter of the plug so that no clearance is formed between the gear case and the plug with the plug press-fitted.

However, in the electric power steering device disclosed in JP2012-197029A, if the outer diameter of the plug is increased, an outer peripheral surface of the plug or an inner peripheral surface of the through hole may be shaved when the plug is press-fitted and shavings may enter the gear case.

The present invention aims to enable a reduction in the number of components of an electric power steering device while preventing the entrance of shavings into a gear case.

According to one aspect of the present invention, an electric power steering device includes a worm shaft configured to rotate as an electric motor is driven; a worm wheel meshed with the worm shaft, the worm wheel being configured to transmit a rotational force of the electric motor to a rack shaft for turning wheels; a bearing rotatably supporting the worm shaft; a biasing member configured to bias the worm shaft toward the worm wheel via the bearing; a gear case housing the worm shaft and the bearing and including an insertion hole, the biasing member being insertable into the insertion hole; and a closing member configured to close the insertion hole. The closing member includes a body part arranged in the insertion hole and configured to be in contact with an inner peripheral surface of the insertion hole, and a supporting part formed to be continuous with the body part toward the bearing and configured to support the biasing member. An outer peripheral surface of the closing member is formed into a curved surface from the body part to the supporting part.

According to another aspect of the present invention, a method for manufacturing an electric power steering device is provided. The electric power steering device includes a biasing member configured to bias a worm shaft toward a worm wheel via a bearing; a gear case housing the worm shaft and the bearing and including an insertion hole, the biasing member being insertable into the insertion hole; and a closing member configured to close the insertion hole. The closing member includes a body part arranged in the insertion hole and configured to be in contact with an inner peripheral surface of the insertion hole, and a supporting part formed to be continuous with the body part toward the bearing and configured to support the biasing member. an outer peripheral surface of the closing member is formed into a curved surface from the body part to the supporting part. The gear case including a tubular part surrounding the worm shaft and the bearing and formed with the insertion hole, and a bottom part closing an opening end of the tubular part. The method includes press-fitting the closing member into the insertion hole with the projecting part projecting from the bottom part supported.

### BRIEF DESCRIPTION OF DRAWINGS

FIG. 1 is a sectional view showing an electric power steering device according to a first embodiment of the present invention;

FIG. 2 is an enlarged sectional view showing the periphery of a closing member in FIG. 1;

FIG. 3 is an enlarged sectional view, corresponding to FIG. 2, showing an electric power steering device according to a modification of the first embodiment;

FIG. 4 is a diagram explaining a method for manufacturing the electric power steering device according to the first embodiment;

FIG. 5 is a sectional view showing an electric power steering device according to a second embodiment of the present invention;

FIG. 6 is an enlarged sectional view showing the periphery of a closing member in FIG. 5; and

FIG. 7 is a diagram explaining a method for manufacturing the electric power steering device according to the second embodiment.

### DESCRIPTION OF EMBODIMENTS

Hereinafter, an electric power steering device 100 according to an embodiment of the present invention is described with reference to the drawings.

### First Embodiment

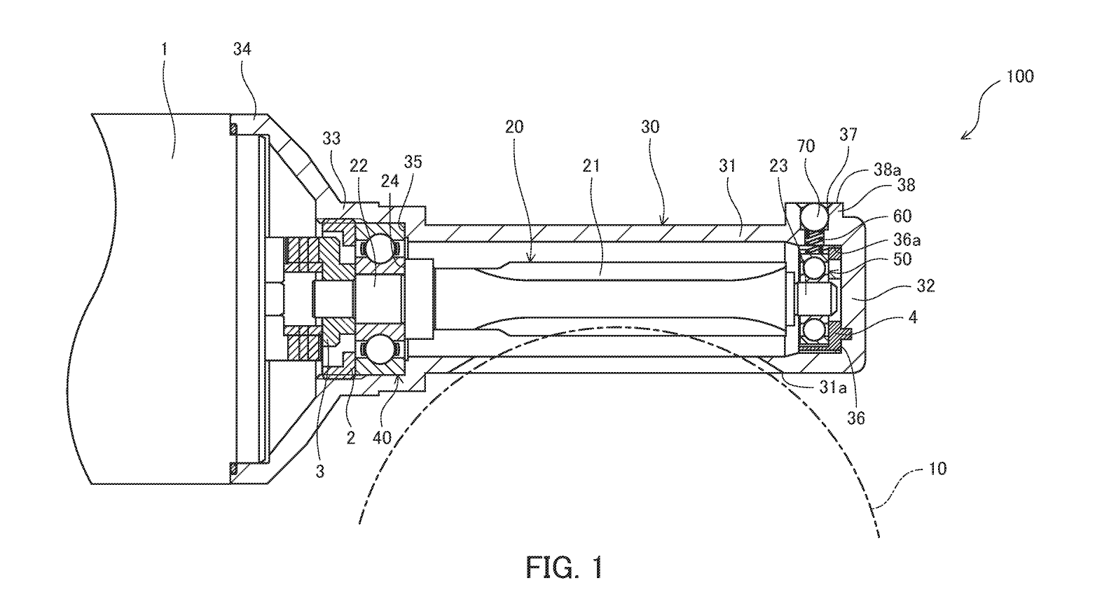

First, the electric power steering device 100 according to a first embodiment of the present invention is described with reference to FIGS. 1 to 4. The electric power steering device 100 is mounted in a vehicle and assists a steering force applied to a steering wheel by a driver.

As shown in FIG. 1, the electric power steering device 100 includes a worm shaft 20 coupled to an output shaft of an electric motor 1 and a worm wheel 10 meshed with the worm shaft 20. The worm shaft 20 rotates as the electric motor 1 is driven. The worm wheel 10 rotates according to the rotation of the worm shaft 20 and transmits a rotational force of the electric motor 1 to a rack shaft for turning wheels. The rotation of the worm shaft 20 is decelerated and transmitted to the worm wheel 10. In this way, a worm speed reducer is constituted by the worm wheel 10 and the worm shaft 20.

A steering shaft (not shown) includes an input shaft coupled to the steering wheel, an output shaft coupled to the rack shaft and a torsion bar coupling the input shaft and the output shaft. The worm wheel 10 is provided on the output shaft of the steering shaft.

The torsion bar is twisted by relative rotation of the input shaft and the output shaft. The electric motor 1 outputs a torque corresponding to a steering torque calculated on the basis of a twisted amount of the torsion bar. The torque output from the electric motor 1 is transmitted from the worm shaft 20 to the worm wheel 10 and imparted as an assist torque to the output shaft of the steering shaft.

The worm shaft 20 is housed in a gear case 30 made of aluminum. The gear case 30 is formed into a bag shape. Specifically, the gear case 30 includes a tubular part 31 surrounding the worm shaft 20 around an axis of the worm shaft 20 and a bottom part 32 for closing one opening end of the tubular part 31. The tubular part 31 and the bottom part 32 are integrally formed. Since no liquid flows into the tubular part 31 from between the tubular part 31 and the bottom part 32, the bag-shaped gear case 30 is excellent in waterproofness as compared to a structure in which the opening of the tubular part 31 is sealed by a lid member separate from the tubular part 31.

The gear case 30 further includes a first large-diameter part 33 having a larger inner diameter than an inner diameter of the tubular part 31 and a second large-diameter part 34 having a larger inner diameter than the inner diameter of the first large-diameter part 33. The first large-diameter part 33 is formed to be continuous from the other opening end of the tubular part 31, and the second large-diameter part 34 is formed to be continuous from the first large-diameter part 33. The electric motor 1 is mounted in the second large-diameter part 34.

The tubular part 31 of the gear case 30 includes a wheel hole 31a into which a part of the worm wheel 10 is insertable. The wheel hole 31a penetrates between outer and inner peripheral surfaces of the tubular part 31 and extends in an axial direction of the worm shaft 20.

A tooth part 21 meshed with a tooth part (not shown) of the worm wheel 10 is formed on a part of the worm shaft 20. The tooth part 21 of the worm shaft 20 and the tooth part of the worm wheel 10 are meshed through the wheel hole 31a.

Both end parts 22, 23 of the worm shaft 20 are respectively rotatably supported by a first bearing 40 and a second bearing 50. The end part 22 located on the side of the electric motor 1 with respect to the tooth part 21 is also referred to as a “base end part 22” and the end part 23 located on a side opposite to the electric motor 1 with respect to the tooth part 21 is also referred to as a “tip part 23” below.

The first bearing 40 supports the base end part 22 and the second bearing 50 supports the tip part 23. Each of the first and second bearings 40, 50 is a bearing including an annular inner ring, an annular outer ring and balls arranged between the inner and outer rings.

The outer ring of the first bearing 40 is fixed to an inner peripheral surface of the first large-diameter part 33 of the gear case 30. Specifically, a step part 35 is formed on an inner peripheral surface of the gear case 30, and a lock nut 2 is fastened in the first large-diameter part 33. The outer ring of the first bearing 40 is sandwiched by the step part 35 and the lock nut 2.

The inner ring of the first bearing 40 is fixed to an outer peripheral surface of the base end part 22 of the worm shaft 20. Specifically, a step part 24 is formed on an outer peripheral surface of the worm shaft 20, and a joint 3 is press-fitted into the worm shaft 20. The inner ring of the first bearing 40 is sandwiched by the step part 24 and the joint 3.

Since the outer ring of the first bearing 40 is fixed to an inner peripheral surface of the gear case 30 and the inner ring of the first bearing 40 is fixed to the outer peripheral surface of the worm shaft 20, a movement of the worm shaft 20 in the axial direction with respect to the gear case 30 is restricted.

The second bearing 50 is housed in a holder 4. The holder 4 is arranged in a bearing housing part 36 formed on the side of the bottom part 32 in the tubular part 31. An inner peripheral surface 36a of the bearing housing part 36 is formed to be circular.

The second bearing 50 is biased by a coil spring 60 serving as a biasing member in a direction to make a clearance between the tooth part 21 of the worm shaft 20 and the tooth part of the worm wheel 10 smaller. That is, the electric power steering device 100 includes the coil spring 60 for biasing the worm shaft 20 toward the worm wheel 10 via the second bearing 50.

An insertion hole 37 into which the coil spring 60 is insertable is formed near the bottom part 32 in the tubular part 31. Specifically, the insertion hole 37 is formed in a hole forming part 38 projecting in a radial direction of the worm shaft 20 from an outer peripheral surface of the tubular part 31. The insertion hole 37 penetrates between an outer surface 38a of the hole forming part 38 and the inner peripheral surface 36a of the bearing housing part 36. A center axis of the insertion hole 37 substantially coincides with the radial direction of the worm shaft 20.

The insertion hole 37 is sealed by a plug 70 made of steel and serving as a closing member. The coil spring 60 is compressed between the plug 70 and the second bearing 50. Thus, the coil spring 60 exhibits a restoring force and this restoring force acts on the second bearing 50 as a biasing force for biasing the worm shaft 20 toward the worm wheel 10.

The inner peripheral surface of the holder 4 is formed into an elongate hole, so that the second bearing 50 is movable in a biasing direction of the coil spring 60. Specifically, a pair of flat surface parts facing each other are formed on the inner peripheral surface of the holder 4. The pair of flat surface parts extend in the biasing direction of the coil spring 60. Further, an interval between the pair of flat surface parts is slightly larger than an outer diameter of the second bearing 50. Thus, a movement of the second bearing 50 is not restrained by the inner peripheral surface of the holder 4 and the second bearing 50 is movable in the biasing direction of the coil spring 60 in the holder 4.

The second bearing 50 may not be housed in the holder 4. The second bearing 50 may be directly housed in the bearing housing part 36 if the second bearing 50 is movable in the biasing direction of the coil spring 60.

As the electric power steering device 100 is driven, the tooth part 21 of the worm shaft 20 and the tooth part of the worm wheel 10 are worn. Since the second bearing 50 is biased by the coil spring 60, the second bearing 50 moves in the holder 4 according to a wear amount of the tooth part 21 of the worm shaft 20 and the tooth part of the worm wheel 10. Thus, backlash between the tooth part 21 of the worm shaft 20 and the tooth part of the worm wheel 10 is reduced.

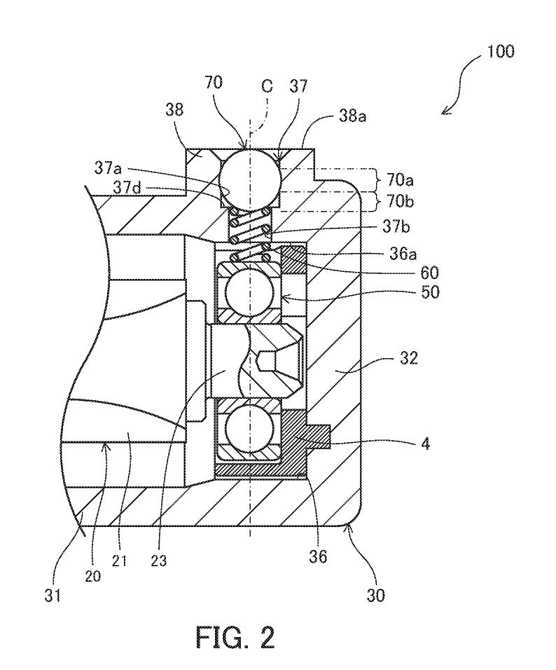

Next, the plug 70 is specifically described with reference to FIG. 2. FIG. 2 is an enlarged sectional view showing the periphery of the plug 70.

The plug 70 is formed into a spherical shape. An outer diameter of the plug 70 is larger than a coil diameter of the coil spring 60.

The insertion hole 37 includes an outer hole part 37a open in the outer surface 38a of the hole forming part 38 and an inner hole part 37b open in the inner peripheral surface 36a of the bearing housing part 36. An inner diameter of the inner hole part 37b is smaller than that of the outer hole part 37a and the inner hole part 37b and the outer hole part 37a are formed to be coaxially continuous. That is, a center axis C of the insertion hole 37 coincides with a center axis of the outer hole part 37a and coincides with a center axis of the inner hole part 37b. A step part 37d is formed between the outer and inner hole parts 37a, 37b.

The outer hole part 37a is formed such that the plug 70 can be press-fitted thereinto. Specifically, the outer hole part 37a has the inner diameter slightly smaller than the outer diameter of the plug 70 in a state before the plug 70 is press-fitted. By press-fitting the plug 70 into the outer hole part 37a, the plug 70 is arranged in the outer hole part 37a. The inner hole part 37b has the inner diameter smaller than the outer diameter of the plug 70, so that the plug 70 cannot be press-fitted thereinto.

The outer surface 38a of the hole forming part 38 is formed into a flat surface. The plug 70 is so arranged in the outer hole part 37a that a tangent plane at the surface of the plug 70 forms the same plane as the outer surface 38a. A clearance is formed between the step part 37d and the plug 70. Since the plug 70 is not in contact with the step part 37d, the plug 70 may be press-fitted into the outer hole part 37a until the tangent plane of the plug 70 forms the same plane as the outer surface 38a of the hole forming part 38 and a push-in amount of the plug 70 is easily managed.

The coil spring 60 is arranged through the inner hole part 37b. The inner diameter of the inner hole part 37b is slightly larger than the coil diameter of the coil spring 60. Thus, the inner hole part 37b prevents the coil spring 60 from being bent without restraining the extension and contraction of the coil spring 60.

A central part 70a of the plug 70 in a center axis direction of the insertion hole 37 is in contact with an inner peripheral surface of the outer hole part 37a. Thus, no clearance is formed between an outer peripheral surface of the central part 70a and the outer hole part 37a and the gear case 30 is tightly sealed.

A lower part 70b of the plug 70 located closer to the coil spring 60 than the central part 70a supports the coil spring 60. Since the plug 70 closes the insertion hole 37 and supports the coil spring 60, it is not necessary to provide the electric power steering device 100 with a member for supporting the coil spring 60 separately from the plug 70. Thus, the number of components of the electric power steering device 100 can be reduced.

Since a surface of the lower part 70b of the plug 70 is formed into a spherical surface, the coil spring 60 moves such that an axis of the coil spring 60 coincides with the center axis C of the insertion hole 37 when the coil spring 60 is supported by the plug 70 by press-fitting the plug 70 into the outer hole part 37a. Thus, the coil spring 60 can be easily arranged at a desired position.

Since the plug 70 has a spherical shape, no corner part is formed on the plug 70. Accordingly, the outer peripheral surface of the plug 70 and the inner peripheral surface of the outer hole part 37a are difficult to shave in press-fitting the plug 70 into the outer hole part 37a of the insertion hole 37. Thus, the entrance of shavings into the gear case 30 can be prevented while the outer diameter of the plug 70 is increased.

Further, by increasing the outer diameter of the plug 70, the inner peripheral surface of the outer hole part 37a can be deformed to conform to the outer peripheral surface of the plug 70 as the plug 70 is press-fitted. Accordingly, with the plug 70 press-fitted, no clearance is formed between the inner peripheral surface of the outer hole part 37a and the outer peripheral surface of the plug 70 and the insertion hole 37 is closed by the plug 70. Thus, it is not necessary to provide a sealing member between the inner peripheral surface of the outer hole part 37a and the outer peripheral surface of the plug 70, wherefore the number of components of the electric power steering device 100 can be reduced.

Furthermore, since no sealing member is necessary between the inner peripheral surface of the outer hole part 37a and the outer peripheral surface of the plug 70, a step of mounting a sealing member on the plug 70 or in the outer hole part 37a is not necessary when manufacturing (assembling) the electric power steering device 100. Thus, a manufacturing time of the electric power steering device 100 can be shortened.

As just described, according to the electric power steering device 100, the number of components can be reduced and the manufacturing time can be shortened while the entrance of shavings into the gear case 30 is prevented.

Further, the plug 70 is made of steel and the hole forming part 38 is made of aluminum. Since the hardness of steel is higher than that of aluminum, the plug 70 is difficult to chip off in press-fitting the plug 70 into the outer hole part 37a and abrasion is unlikely to occur between the outer peripheral surface of the plug 70 and the inner peripheral surface of the outer hole part 37a. Thus, the production of shavings can be more reliably prevented in press-fitting the plug 70 into the outer hole part 37a.

The electric power steering device 100 is not limited to such a form that the plug 70 is made of steel and the hole forming part 38 is made of aluminum. If the hardness of the plug 70 is higher than that of an inner peripheral wall of the insertion hole 37, the production of shavings can be prevented.

Spherical members are used in many devices and a technique for manufacturing the spherical members is established. Since the plug 70 is formed into a spherical shape in the electric power steering device 100, the plug 70 can be more easily manufactured.

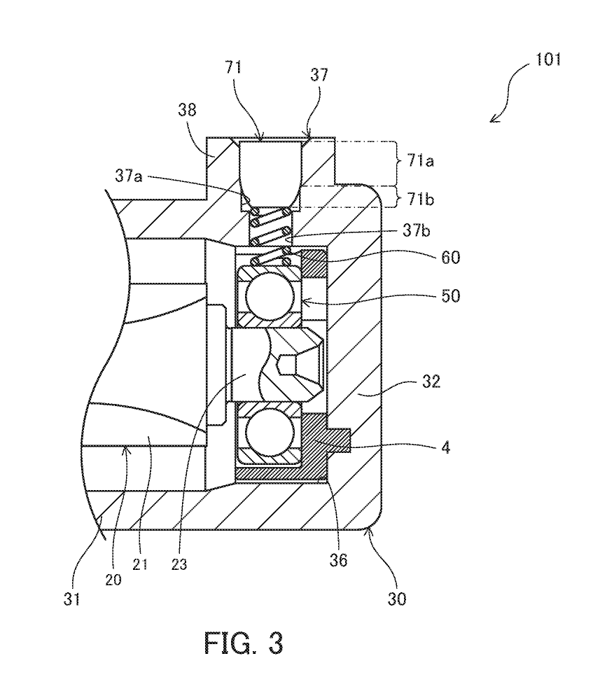

FIG. 3 is an enlarged sectional view, corresponding to FIG. 2, showing an electric power steering device 101 according to a modification of the first embodiment. The electric power steering device 101 includes a non-spherical plug 71 as a closing member instead of the spherical plug 70.

The plug 71 includes a body part 71a arranged in the outer hole part 37a and a supporting part 71b for supporting the coil spring 60. The body part 71a is formed into a cylindrical column and in contact with the inner peripheral surface of the outer hole part 37a. The supporting part 71b is formed to be continuous with the body part 71a toward the second bearing 50.

The outer peripheral surface of the plug 71 is formed into a curved surface curved to the inside of the insertion hole 37 from the body part 71a to the supporting part 71b. In other words, there is no corner part on a boundary part between the body part 71a and the supporting part 71b. Since the boundary part between the body part 71a and the supporting part 71b is in the form of a curved surface, the outer peripheral surface of the plug 71 and the inner peripheral surface of the outer hole part 37a are difficult to shave in press-fitting the plug 71. Thus, similarly to the spherical plug 70 (see FIGS. 1 and 2), the number of components can be reduced and the manufacturing time can be shortened while the entrance of shavings into the gear case 30 is prevented.

As just described, the shape of the closing member is not limited to the spherical shape. The closing member may include the body part arranged in the insertion hole 37 and the supporting part for supporting the coil spring 60. The outer peripheral surface of the closing member may be formed into a curved surface from the body part to the supporting part. In the spherical plug 70 shown in FIG. 2, the central part 70a is equivalent to the body part and the lower part 70b is equivalent to the supporting part.

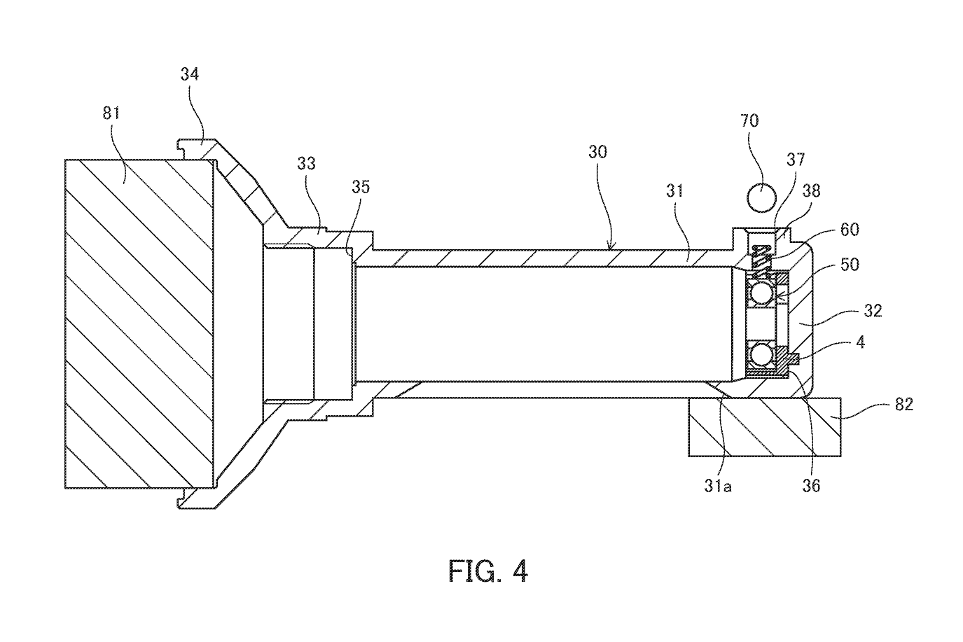

Next, a method for manufacturing the electric power steering device 100 is described with reference to FIG. 4.

First, the second bearing 50 is housed into the holder 4 and the holder 4 is housed into the bearing housing part 36. Subsequently, the coil spring 60 is inserted into the insertion hole 37.

Subsequently, as shown in FIG. 4, the gear case 30 is supported using supporting tools 81, 82. Specifically, the supporting tool 81 is fitted into the second large-diameter part 34 and the tubular part 31 is placed on the supporting tool 82. At this time, the tubular part 31 is placed on the supporting tool 82 such that the hole forming part 38 is located on a side opposite to the supporting tool 82 with respect to a center axis of the tubular part 31.

Subsequently, the plug 70 is press-fitted into the outer hole part 37a of the insertion hole 37 to compress the coil spring 60 between the second bearing 50 and the plug 70. Since the hole forming part 38 is located on the side opposite to the supporting tool 82, the plug 70 is press-fitted toward the supporting tool 82. Thus, the tubular part 31 is reliably supported and the plug 70 can be easily press-fitted into the outer hole part 37a.

As the plug 70 is press-fitted, the inner peripheral surface of the outer hole part 37a is deformed to conform to the outer peripheral surface of the plug 70 when press-fitting the plug 70. Thus, no clearance is formed between the inner peripheral surface of the outer hole part 37a and the outer peripheral surface of the plug 70 and the insertion hole 37 can be closed only by the plug 70.

Subsequently, the supporting tool 81 is pulled out from the second large-diameter part 34. The worm shaft 20 is inserted into the gear case 30 and the tip part 23 of the worm shaft 20 is inserted into the second bearing 50. The assembling of the electric motor 1 and the worm wheel 10 into the gear case 30 is not described here.

Since the outer peripheral surface of the plug 70 is formed into a curved surface from the central part 70a to the lower part 70b in the present embodiment, the outer peripheral surface of the plug 70 and the inner peripheral surface of the outer hole part 37a are difficult to shave when press-fitting the plug 70. Thus, the entrance of shavings into the gear case 30 can be prevented.

Further, since no clearance is formed between the inner peripheral surface of the outer hole part 37a and the outer peripheral surface of the plug 70, it is not necessary to provide a sealing member between the inner peripheral surface of the outer hole part 37a and the outer peripheral surface of the plug 70. Thus, a step of mounting the sealing member on the plug 70 or in the outer hole part 37a can be omitted, whereby the manufacturing time can be shortened.

### Second Embodiment

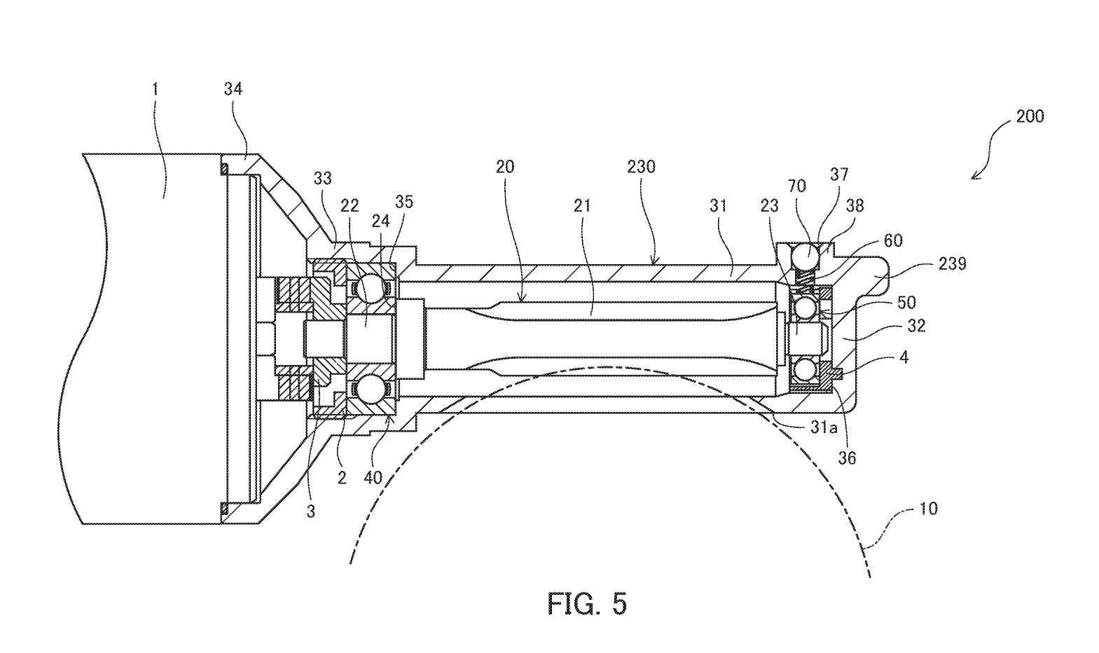

An electric power steering device 200 according to a second embodiment of the present invention is described below with reference to FIGS. 5 to 7. The same components as those in the first embodiment are denoted by the same reference signs and not described.

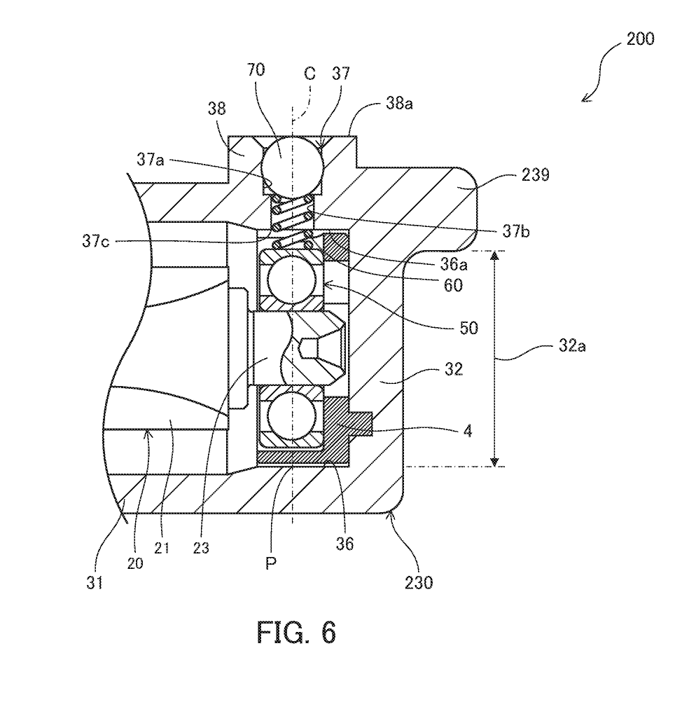

As shown in FIGS. 5 and 6, a gear case 230 further includes a projecting part 239 projecting from a bottom part 32 in an axial direction of a worm shaft 20. The projecting part 239 is supported in press-fitting a plug 70 into an outer hole part 37a. That is, the projecting part 239 functions as a pressure-receiving part for receiving a press-fitting load in press-fitting the plug 70 into an insertion hole 37 when assembling the electric power steering device 200.

As described in the first embodiment, when the plug 70 is press-fitted into the outer hole part 37a with a tubular part 31 supported, a force is applied to the tubular part 31. Accordingly, the tubular part 31 may be deformed and a bearing housing part 36 and a holder 4 may be squeezed in a biasing direction of a coil spring 60. If the bearing housing part 36 and the holder 4 are squeezed, a moving range of a second bearing 50 may be narrowed. Depending on a squeezing degree of the bearing housing part 36 and the holder 4, a movement of the second bearing 50 may be completely restrained.

In the electric power steering device 200, the plug 70 may be press-fitted into the outer hole part 37a with the projecting part 239 supported, and the tubular part 31 needs not be supported. Accordingly, it can be prevented that a force is applied to the tubular part 31 and the bearing housing part 36 and the holder 4 are squeezed. As a result, it can be prevented that the moving range of the second bearing 50 is narrowed.

The projecting part 239 is located closer to the insertion hole 37 than an intersection P of an inner peripheral surface 36a of the bearing housing part 36 and a center axis C of the insertion hole 37. Accordingly, no force is applied to a part 32a of the bottom part 32 between the projecting part 239 and the intersection P in press-fitting the plug 70 into the outer hole part 37a with the projecting part 239 supported. Thus, the compression of the part 32a due to the press-fitting of the plug 70 can be prevented and the squeezing of the bearing housing part 36 and the holder 4 can be more reliably prevented.

The projecting part 239 is more preferably located closer to the insertion hole 37 than an opening 37c of the insertion hole 37 formed in an inner peripheral surface of the tubular part 31. Since no force is applied to the entire bottom part 32 when press-fitting the plug 70, the compression of the bottom part 32 can be prevented and the squeezing of the bearing housing part 36 and the holder 4 can be more reliably prevented.

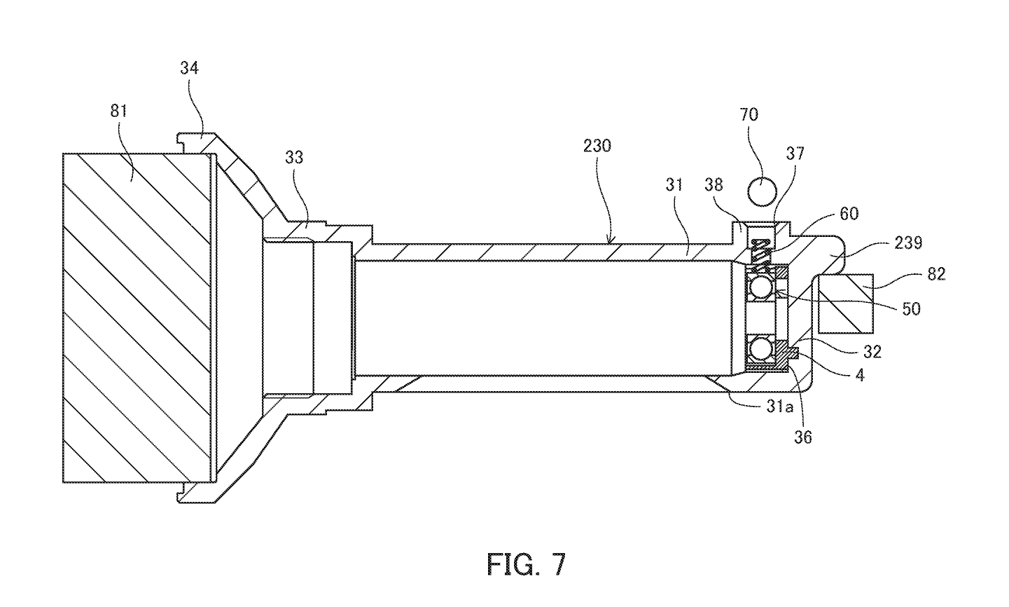

Next, a method for manufacturing the electric power steering device 200 is described with reference to FIG. 7.

As in the first embodiment, the second bearing 50 is housed into the holder 4, the holder 4 is housed into the bearing housing part 36, and the coil spring 60 is inserted into the insertion hole 37.

Subsequently, as shown in FIG. 7, the gear case 30 is supported using supporting tools 81, 82. Specifically, the supporting tool 81 is fitted into a second large-diameter part 34 and the projecting part 239 is placed on the supporting tool 82.

Subsequently, the plug 70 is press-fitted into the outer hole part 37a of the insertion hole 37 and the supporting tool 81 is pulled out from the second large-diameter part 34. Thereafter, a worm shaft 20 is inserted into the gear case 30 and a tip part 23 of the worm shaft 20 is inserted into the second bearing 50. The assembling of an electric motor 1 and a worm wheel 10 into the gear case 30 is not described here.

Since the plug 70 is press-fitted into the insertion hole 37 with the projecting part 239 supported in the present embodiment, it can be prevented that a force is applied to the tubular part 31 and the bearing housing part 36 and the holder 4 are squeezed. As a result, it can be prevented that the moving range of the second bearing 50 is narrowed.

Since the projecting part 239 is located closer to the hole forming part 38 than the intersection P of the inner peripheral surface 36a of the bearing housing part 36 and the center axis C of the insertion hole 37, no force is applied to the part 32a of the bottom part 32 between the projecting part 239 and the intersection P. Thus, the compression of the part 32a due to the press-fitting of the plug 70 can be prevented and the squeezing of the bearing housing part 36 and the holder 4 can be more reliably prevented.

After the plug 70 is press-fitted into the insertion hole 37, the projecting part 239 may be removed from the gear case 230.

The configuration, functions and effects of the embodiments of the present invention are summarized below.

The electric power steering device 100, 101, 200 includes the worm shaft 20 configured to rotate as the electric motor 1 is driven, the worm wheel 10 meshed with the worm shaft 20 and configured to transmit a rotational force of the electric motor 1 to the rack shaft for turning the wheels, the bearing 50 configured to rotatably support the worm shaft 20, the coil spring 60 configured to bias the worm shaft 20 toward the worm wheel 10 via the bearing 50, the gear case 30, 230 configured to house the worm shaft 20 and the bearing 50 and including the insertion hole 37 into which the coil spring 60 is insertable, and the plug 70, 71 configured to close the insertion hole 37, the plug 70, 71 includes the body part 70a, 71a arranged in the insertion hole 37 and in contact with an inner peripheral surface of the insertion hole 37 and the supporting part 70b, 71b formed to be continuous with the body part 70a, 71a toward the bearing 50 and configured to support the coil spring 60, and the outer peripheral surface of the plug 70, 71 is formed into a curved surface from the body part 70a, 71a to the supporting part 70b, 71b.

Since the outer peripheral surface of the plug 70, 71 is formed into a curved surface from the body part 70a, 71a to the supporting part 70b, 71b in this configuration, even if the outer diameter of the plug 70, 71 is increased, the outer peripheral surface of the plug 70, 71 and the inner peripheral surface of the insertion hole 37 are difficult to shave in press-fitting the plug 70, 71 into the insertion hole 37. Thus, the entrance of shavings into the gear case 30, 230 can be prevented while the outer diameter of the plug 70, 71 is increased. Further, since the outer diameter of the plug 70, 71 can be increased, it is not necessary to provide a sealing member between the inner peripheral surface of the insertion hole 37 and the outer peripheral surface of the plug 70, 71. Thus, the number of components can be reduced and the manufacturing time can be shortened.

In the electric power steering device 100, 101, 200, the hardness of the plug 70, 71 is higher than that of the inner peripheral wall of the insertion hole 37.

Since the hardness of the plug 70, 71 is higher than that of the inner peripheral wall of the insertion hole 37 in this configuration, the plug 70, 71 is difficult to chip off and abrasion is unlikely to occur between the outer peripheral surface of the plug 70, 71 and the inner peripheral surface of the insertion hole 37 in press-fitting the plug 70, 71 into the insertion hole 37. Thus, the production of shavings can be more reliably prevented in press-fitting the plug 70, 71 into the insertion hole 37.

Further, in the electric power steering device 100, 200, the plug 70 is formed into a spherical shape.

Since the plug 70 is formed into a spherical shape in this configuration, the plug 70 has no corner part. Thus, the production of shavings can be more reliably prevented in press-fitting the plug 70 into the insertion hole 37.

Further, in the electric power steering device 200, the gear case 230 includes the tubular part 31 surrounding the worm shaft 20 and the bearing 50 and formed with the insertion hole 37, the bottom part 32 configured to close the opening end of the tubular part 31 and the projecting part 239 projecting from the bottom part 32, and the projecting part 239 functions as the pressure-receiving part configured to receive a press-fitting load in press-fitting the plug 70, 71 into the insertion hole 37 when assembling the electric power steering device 200.

In this configuration, the plug 70, 71 may be press-fitted into the insertion hole 37 with the projecting part 239 supported, and no force is applied to the tubular part 31. Thus, the deformation of the tubular part 31 can be prevented.

Further, in the electric power steering device 200, the projecting part 239 is located closer to the insertion hole 37 than the intersection P of the inner peripheral surface of the tubular part 31 and the center axis C of the insertion hole 37.

In this configuration, the projecting part 239 is located closer to the insertion hole 37 than the intersection P of the inner peripheral surface of the tubular part 31 and the center axis C of the insertion hole 37. Accordingly, no force is applied to the part 32a of the bottom part 32 between the projecting part 239 and the intersection P in press-fitting the plug 70, 71 into the insertion hole 37 with the projecting part 239 supported. Thus, the deformation of the part 32a associated with the press-fitting of the plug 70, 71 can be prevented.

Further, in the electric power steering device 200, the projecting part 239 is located closer to the insertion hole 37 than the opening 37c of the insertion hole 37 formed in the inner peripheral surface of the tubular part 31.

In this configuration, the projecting part 239 is located closer to the insertion hole 37 than the opening 37c of the insertion hole 37 formed in the inner peripheral surface of the tubular part 31. Accordingly, no force is applied to the entire bottom part 32 in press-fitting the plug 70, 71 into the insertion hole 37 with the projecting part 239 supported. Thus, the deformation of the bottom part 32 associated with the press-fitting of the plug 70, 71 can be prevented.

Further, the electric power steering device 200 includes the coil spring 60 configured to bias the worm shaft 20 toward the worm wheel 10 via the bearing 50, the gear case 230 configured to house the worm shaft 20 and the bearing 50 and including the insertion hole 37 into which the coil spring 60 is insertable, and the plug 70, 71 configured to close the insertion hole 37, the plug 70, 71 includes the body part 70a, 71a arranged in the insertion hole 37 and in contact with the inner peripheral surface of the insertion hole 37 and the supporting part 70b, 71b formed to be continuous with the body part 70a, 71a toward the bearing 50 and configured to support the coil spring 60, the outer peripheral surface of the plug 70, 71 is formed into a curved surface from the body part 70a, 71a to the supporting part 70b, 71b, and the gear case 230 includes the tubular part 31 surrounding the worm shaft 20 and the bearing 50 and formed with the insertion hole 37 and the bottom part 32 configured to close the opening end of the tubular part 31. The method for manufacturing the electric power steering device 200 includes press-fitting the plug 70, 71 into the insertion hole 37 with the projecting part 239 projecting from the bottom part 32 supported.

Since the plug 70, 71 is press-fitted into the insertion hole 37 with the projecting part 239 supported in this configuration, no force is applied to the tubular part 31. Thus, the deformation of the tubular part 31 can be prevented.

The embodiments of the present invention described above are merely illustration of some application examples of the present invention and not of the nature to limit the technical scope of the present invention to the specific constructions of the above embodiments.

For example, in the above embodiments, the worm wheel 10 is provided on the output shaft of the steering shaft. Instead of this configuration, the worm wheel 10 may be provided on a pinion shaft provided separately from the steering shaft and meshed with the rack shaft.

Further, in the above embodiments, the electric power steering device 100, 101, 200 assists a steering force applied to the steering wheel by the driver. Instead of this use, the electric power steering device 100, 101, 200 may be used as a steering device during autonomous operation of a vehicle.

Further, in the above embodiments, the coil spring 60 is used as the biasing member. The biasing member may be an elastic body such as a leaf spring or rubber.

The present application claims a priority based on Japanese Patent Application No. 2016-62161 filed with the Japan Patent Office on Mar. 25, 2016, all the contents of which are hereby incorporated by reference.

1. An electric power steering device, comprising:
a worm shaft configured to rotate as an electric motor is driven;
a worm wheel meshed with the worm shaft, the worm wheel being configured to transmit a rotational force of the electric motor to a rack shaft for turning wheels;
a bearing rotatably supporting the worm shaft;
a biasing member configured to bias the worm shaft toward the worm wheel via the bearing;
a gear case housing the worm shaft and the bearing and including an insertion hole, the biasing member being insertable into the insertion hole; and
a closing member configured to close the insertion hole, wherein
the closing member includes a body part arranged in the insertion hole and configured to be in contact with an inner peripheral surface of the insertion hole, and a supporting part formed to be continuous with the body part toward the bearing and configured to support the biasing member; and
an outer peripheral surface of the closing member is formed into a curved surface from the body part to the supporting part.

2. The electric power steering device according to claim 1, wherein
the hardness of the closing member is higher than the hardness of an inner peripheral wall of the insertion hole.

3. The electric power steering device according to claim 1, wherein
the closing member is formed into a spherical shape.

4. The electric power steering device according to claim 1, wherein
the gear case includes a tubular part surrounding the worm shaft and the bearing and formed with the insertion hole, a bottom part closing an opening end of the tubular part, and a projecting part projecting from the bottom part, and
the projecting part functions as a pressure-receiving part configured to receive a press-fitting load in press-fitting the closing member into the insertion hole when assembling the electric power steering device.

5. The electric power steering device according to claim 4, wherein
the projecting part is located closer to the insertion hole than an intersection of an inner peripheral surface of the tubular part and a center axis of the insertion hole.

6. The electric power steering device according to claim 5, wherein
the projecting part is located closer to the insertion hole than an opening of the insertion hole formed in the inner peripheral surface of the tubular part.

7. A method for manufacturing an electric power steering device, the electric power steering device comprising:
a biasing member configured to bias a worm shaft toward a worm wheel via a bearing;
a gear case housing the worm shaft and the bearing and including an insertion hole, the biasing member being insertable into the insertion hole; and
a closing member configured to close the insertion hole, wherein
the closing member includes a body part arranged in the insertion hole and configured to be in contact with an inner peripheral surface of the insertion hole, and a supporting part formed to be continuous with the body part toward the bearing and configured to support the biasing member;
an outer peripheral surface of the closing member is formed into a curved surface from the body part to the supporting part; and
the gear case including a tubular part surrounding the worm shaft and the bearing and formed with the insertion hole, and a bottom part closing an opening end of the tubular part, the method comprising
press-fitting the closing member into the insertion hole with the projecting part projecting from the bottom part supported.
